(19) United States
(12) Patent Application Publication
(10) Pub. No.: US 2005/0221093 A1
(43) Pub. Date: Oct. 6, 2005

(54) Laminate sheet material and a process for its production

(75) Inventor: Dirk Pophusen, Bergisch Gladbach (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/098,359

(22) Filed: Mar. 31, 2005

(30) Foreign Application Priority Data
Apr. 6, 2004 (DE) 102004016898.9

(51) Int. Cl. B32B 27/34; B32B 27/32; B32B 27/30; B32B 27/36; B05D 3/12

(52) U.S. Cl. 428/412; 428/521; 428/522; 428/428; 428/474.4; 427/366

(57) ABSTRACT

A process for producing a laminate that exhibits an orange peel effect having a wavescan DOI value of 5 to 80 as determined by BYK Gardner apparatus is disclosed. The process comprise a) obtaining a carrier layer a first surface of which exhibits specifically measured roughness value and b) applying a sealing layer to the first surface, the protective layer positioned on the side remote from the carrier film. The inventive laminate is particularly suitable in automotive applications.

### FIELD OF THE INVENTION

The invention relates to a laminate and more particularly to a laminate that includes polymeric films and a process for its production.

### BACKGROUND OF THE INVENTION

The present invention relates to a laminate sheet material that exhibits a so-called “orange peel” effect and a process for its production.

Plastics are nowadays widely used in the automobile industry. In the outer car body parts sector plastics compete with painted metal or plastics structural parts. In order to open up new applications in this field plastics structural parts in addition to painted metal or plastics structural parts have to be developed that satisfy mechanical properties such as scratch resistance and chemical resistance, as well as optical requirements. In particular the so-called “orange peel” effect that is often preferred in painted structural parts then has to be simulated also with plastics structural parts, which is a complicated procedure.

In the roof module sector the use of lightweight materials with a high rigidity and low screening effect (good aerial signal reception) is required. PU (polyurethane) rigid foam systems such as the so-called LFI (Long Fibre Injection) or S-RIM systems. (Structural Reaction Injection Molding or also Structural Resin Injection Molding) have major advantages compared to competing systems such as for example SMC (Sheet Molding Compound). The structured surfaces of LFI or S-RIM structural parts are formed from sheets. These sheets must furthermore, when back-foamed after a preforming, have a very good adhesion to for example the PU system.

The process of sheet back-foaming is described in detail by Haberstroh, Wirtz and Schlumm in the journal FAPU, Issue No. 21 (November/December 2003), pp. 66 to 69.

In the finished structural part the sheet must exhibit in particular the high heat resistance required for roof modules. In particular polycarbonate-based sheets have proved suitable for this purpose. The additional surface strength and chemical resistance is realised via a sealing layer that is applied in a laminating process to the carrier film. The laminate sheets that are thereby obtained then subsequently have to receive the desired orange peel structure resembling car body paint, in a subsequent back-foaming or back-injection molding process. This structure is produced by the surface structure of the mold.

EP 0 320 925 B1 describes a process for producing plastics molded parts with a decoratively embossed surface coating. For this, a non-embossed, thermoformable sheet is placed in a mold that has a structured surface (surface with a pattern; surface with a texture) at least in partial regions of its inner surface, and is then back-injection molded.

In DE 10 064 520 A1 a similar process is described, in which in addition nanostructures are produced (embossed surface having a pattern (a texture) in the dimension of nanometers).

The object was now to provide an economically cost-effective car body sheet material by a reliable production method, which has a high chemical resistance, high scratch resistance, good thermoformability, very good adhesion to the carrier material and, in particular, a surface structure similar to paint (“orange peel effect”), as well as a simple process for its production.

### SUMMARY OF THE INVENTION

A process for producing a laminate having a wavescan DOI value of 5 to 60 as determined by BYK Gardner apparatus is disclosed. The process comprise a) obtaining a carrier layer a first surface of which exhibits specifically measured roughness value and b) applying a sealing layer to the first surface, the protective layer positioned on the side remote from the carrier film. The inventive laminate is particularly suitable in automotive applications.

### DETAILED DESCRIPTION OF THE INVENTION

This object was achieved by the process according to the invention.

The invention provides a process for the production of a laminate, preferably a sheet material, with one surface having a DOI (Distinctness of Image) of 5 to 60 (measured with the “wave scan DOI” measurement apparatus from BYK Gardner GmbH, Geretsried, Germany), (“orange peel effect”) which process entails
a) obtaining a carrier layer (film or composite) having a temperature of 50° C. to 150° C., in which one of the two surfaces (first surface) has a surface roughness Rz of 1 μm to 6 μm according to DIN EN ISO 4288,
b) applying a sealing layer (a film that contains a protective layer or a composite that includes at least one colored layer and a protective layer) having a temperature of 80° C. to 180° C. to the first surface so that the protective layer of the sealing layer is located on the side remote from the carrier layer,
c) carrying the product of b) through two counter rotating rolls whereby at least one of the rolls having a temperature of 80° to 180° C. and thereby pressing the product and achieving the laminate.

The surface roughness Rz of the carrier layer is achieved during its production by extrusion by embossing the surface of the layer by using corresponding surface-structured rotating rolls. The surface structure of the rotating rolls determines the surface roughness Rz of the carrier layer (film).

By laminating the sealing layer onto the carrier layer having a defined surface roughness, the so-called orange peel effect is surprisingly produced in a simple way, so that the optics of the corresponding structural part correspond to the optics of a painted car body part.

The sealing layer preferably has a thickness of 20 to 250 μm, particularly preferably 50 to 200 μm.

The laminate produced according to the invention may then be placed in a mold for the production of a structural part (molded part), optionally after a pre-forming, and may be back-injection molded or back-foamed with plastics material. In this connection a perfectly conventional mold may be used, whose surface need not be structured (the surface is even and smooth and optionally polished).

Surprisingly the surface of the carrier layer is not damaged either by the laminating on of the sealing layer, nor by the subsequent back-injection molding in a mold.

The surface roughness of the carrier layer may also be defined via the so-called R3z value. This is a Daimler Benz factory standard (DB N 31007, 1983). The carrier layer used in the process according to the invention preferably have R3z values of 10 μm to 25 μm.

For carrier layers with matted or structured surfaces the determination of the surface roughness according to the Daimler Benz factory standard, i.e. the R3z value instead of the Rz value, has proved convenient and is now standard practice.

Preferably the carrier layer is a film of polycarbonate film or a poly-carbonate blend. The film preferably contains at least one member selected from the group consisting of polycarbonate, acrylonitrile/butadiene/styrene, polymethyl methacrylate, styrene/acrylonitrile, polybutylene terephthalate, polyethylene terephthalate, polyamide, polyesters and acrylic/styrene/acrylonitrile.

As sealing layer there may for example be used films that are described in EP-A 949 120, incorporated herein by reference in its entirety. The films are available from the Soliant company under the trade name Fluorex® Paintfilm.

The laminate produced according to the invention may be used as sheets for structural parts, in particular car body parts, and as scratch-resistant sheets for lightweight molded parts. They may be used for the production of molded parts, in particular roof modules. The laminates may for example be formed in a thermoforming process. After the forming they may be used in the back-injection molding process with thermoplastic materials. They may also be back-foamed or applied to the structural part via an adhesive layer.

The invention also provides a laminate a surface of which having a wave-scan DOI value of 5 to 60 as determined by BYK Gardner apparatus comprising
A) a carrier layer a first surface of which exhibitor roughness value, Rz, of 1 μm to 6 μm determined according to DIN ISO 4288,
B) a sealing layer on said first surface, the protective layer positioned on the side remote from the carrier film,
   said carrier layer containing at least one film of at least one member selected from the group consisting of polycarbonate, ABS, polymethyl methacrylate, styrene/acrylonitrile, polybutylene terephthalate, polyethylene terephthalate, polyamide, polyester, acrylic/styrene/acrylonitrile, said sealing layer including a protective and optionally at least one colored layer.

The R3z value describes the basic roughness depths according to the Daimler Benz factory norm DB N 31007 (1983) and represents the mean value of the individual roughness depths R3zi of five successive individual measurement sections. The individual roughness depth R3zi is the vertical distance from the third highest profile peak to the third lowest profile trough of the roughness profile within an individual measurement section. A detailed description is given in the publication by Mahr GmbH, Jan. 9, 1999 Edition, entitled “Perthometer Oberflächenmessgrβen” [Perthometer Surface Measurement Quantities] incorporated herein by reference.

The evaluation of the surface structures of paints, the so-called “orange peel” effect, is often made visually. The orange peel effect is seen as a wavy pattern and dark fields on shiny surfaces. It is e.g. determined by the DOI.

The DOI (Distinctness of Image) is used as a measurement value for paint surfaces (for orange peel effect), and for ideally smooth surfaces (no orange peel effect) is 100. Normal paints have values in the region of 10.

A detailed description of the DOI and of the measurement process is contained in the brochure entitled “Qualitätskontrolle für Lacke und Kunststoffe” [Quality Control for Paints and Plastics] 2003/2004 from BYK Gardner, incorporated herein by reference. The DOI is measured using a wave-scan DOI instrument from BYK Gardner, Geretsried, Germany.

The roughness depth Rz is the arithmetic mean value of the individual roughness depths Rzi of successive individual measurement sections. The individual roughness depth Rzi is the sum of the largest profile peak and the depth of the largest profile trough of the roughness profile within the individual measurement section. The roughness depth Rz is determined according to DIN EN ISO 4288.

The invention is described in more detail with the aid of the following example.

### EXAMPLE

A two-layer carrier film (film composite) having a total thickness of 1000 μm was produced in a co-extrusion process. The lower layer consisted of a PC/ABS blend (Bayblend® T45 from Bayer MaterialScience AG) and had a thickness of 200 μm, while the upper layer consisted of PC (Makrolon® 3103 from Bayer MaterialScience AG) and had a thickness of 800 μm. The melt leaving the nozzle was cooled using a polishing stack and the surface roughness of the PC layer was adjusted by using surface-structured rollers. This carrier film was then laminated in a laminating process with a velocity of 10 m/min. onto the structured polycarbonate side with a sealing film from Soliant (Fluorex® ISF 2010-Paintfilm). This sealing film that was used included a primer with a thickness of 20 μm, a colored layer with a thickness of 50 μm and a protective layer with a thickness of 50 μm. An easily strippable and formable protective film was located on the protective layer. The laminate sheet thereby produced has a surface structure that corresponds optically to the surface of a painted structural part. This laminate sheet was then formed in a thermoforming process at 190° C. and back-foamed with a PUR integral rigid foam (Baydur® 0768 C/Desmodur® 44V10 from Bayer MaterialScience AG) and used as a structural part for a vehicle roof module.

Measurement Results:

Carrier Film:

R value of the structured side: 3 μm
R3z value of the structured side: 15 μm
DOI according to BYK Gardner: Measurement is technically not possible since on account of the structured surface the gloss of the film is too low for a DOI measurement.
   Laminate Sheet:
DOI according to BYK Gardner: 54.0 (measured with the “wave-scan DOI” measurement device from BYK Gardener GmbH, Geretsried, Germany)

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

1. A process for producing a laminate a surface of which having a wavescan DOI value of 5 to 60 as determined by BYK Gardner apparatus comprising
a) obtaining a carrier layer having a temperature of 50° to 150° C. a first surface of which exhibits roughness value, Rz, of 1 μm to 6 μm determined according to DIN EN ISO 4288,
b) applying a sealing layer having a temperature of 80° to 180° C. to said first surface, the protective layer positioned on the side remote from the carrier film,
c) carrying the product of b) through two counter rotating rolls whereby at least one of the rolls having a temperature of 80° to 180° C. and thereby pressing the product and achieving the laminate,
said carrier layer containing at least one film of at least one member selected from the group consisting of polycarbonate, acrylonitrile/butadiene/styrene, polymethyl methacrylate, styrene/acrylonitrile, polybutylene terephthalate, polyethylene terephthalate, polyamide, polyester, acrylic/styrene/acrylonitrile, said sealing layer including a protective and optionally at least one colored layer.

2. The process of claim 1 wherein the carrier layer is a film comprising polycarbonate.

3. The process of claim 1 wherein the carrier layer is a film of a member selected from the group consisting of polycarbonate and polycarbonate/ABS blend.

4. The process according to claim 1, wherein the carrier layer is a co-extruded laminate.

5. The process according to claim 2 wherein the carrier layer has a surface roughness R3z of 10 μm to 25 μm according to Daimler Benz factory norm DB N 31007 (1983).

6. The laminate prepared by the process of claim 1.

7. A laminate a surface of which having a wave-scan DOI value of 5 to 60 as determined by BYK Gardner apparatus comprising
A) a carrier layer a first surface of which exhibits roughness value, Rz, of 1 μm to 6 μm determined according to DIN ISO 4288,
B) a sealing layer on said first surface, the protective layer positioned on the side remote from the carrier film,
said carrier layer containing at least one film of at least one member selected from the group consisting of polycarbonate, acrylonitrilelbutadiene/styrene, polymethyl methacrylate, styrene/acrylonitrile, polybutylene terephthalate, polyethylene terephthalate, polyamide, polyester, acrylic/styrene/acrylonitrile, said sealing layer including a protective and optionally at least one colored layer.

8. A molded article comprising the laminate of claim 6.
